(19) United States
(12) Patent Application Publication
(10) Pub. No.: US 2026/0261046 A1
(43) Pub. Date: Sep. 3, 2026

(54) MOBILE ELECTRONIC DEVICE, PARTICULARLY HEARING AID, WITH A LOOP ANTENNA

(71) Applicant: Sivantos Pte. Ltd., Singapore (SG)

(72) Inventors: Andreas PFROMMER, Erlangen (DE); Hamed Hasani, Erlangen (DE)

(21) Appl. No.: 19/553,698

(22) Filed: Mar. 2, 2026

(30) Foreign Application Priority Data
Feb. 28, 2025 (DE) 10 2025 107 683.9

(51) Int. Cl. H01Q 7/00; H01Q 1/27; H01Q 5/20

(52) U.S. Cl. CPC H01Q 7/00; H01Q 1/273; H01Q 5/20

(57) ABSTRACT

A mobile electronic device, particularly a hearing aid, includes a loop antenna having a conductor loop with a plurality of electric components, such as a plurality of capacitors and a plurality of coils. The loop antenna is configured as a multi-band antenna and has a first resonance frequency and a second resonance frequency being greater than the first resonance frequency. Particularly, a plurality of component groups configured as series resonant circuits are disposed so as to be distributed in the conductor loop. The two resonance frequencies preferably are at 2.44 GHZ and range from 5 GHZ and 7 GHz.

### CROSS-REFERENCE TO RELATED APPLICATION

This application claims the priority, under 35 U.S.C. § 119, of German Patent Application DE 10 2025 107 683.9, filed Feb. 28, 2025; the prior application is herewith incorporated by reference in its entirety.

### FIELD AND BACKGROUND OF THE INVENTION

The invention relates to a mobile electronic device, particularly a hearing aid, with a loop antenna having a conductor loop with a plurality of electric components.

Such a hearing aid is known, for example, from U.S. Pat. No. 11,342,949 B2. Particularly, the hearing aid described therein is a hearing aid worn in or at the ear. In general, due to the compact geometry, there are requirements for the design and configuration of antennas for such hearing aids, which are employed for wireless Bluetooth communication, for example. In the state of the art mentioned, measures are described to achieve that an effective electric length of the antenna at a specified resonance frequency is greater than the actual physical length such that a sufficient electric antenna length may be provided also in small installation spaces. For that purpose, different variations of conductor loops are suggested.

According to a first variation for configuring a magnetic loop antenna, a plurality of capacitances are integrated and distributed in the conductor loop. In a second variation for configuring a so-called full wave loop antenna, a plurality of inductances are integrated and distributed in the conductor loop. Finally, according to a third variation, a mixed form for configuring a half wave loop antenna is suggested, in which one half of the conductor loop is equipped with a plurality of capacitances and the other half of the conductor loop is equipped with a plurality of inductances.

Such antennas are periodically set and tuned to a specific resonance frequency. For Bluetooth communication, hearing aids are nowadays specifically tuned to the frequency band at 2.4 GHz. If communication is to be performed in other frequency bands, the antenna needs to be modified and/or a plurality of different antennas need to be provided, resulting, however, in additional effort and increased space requirement. The shared use of an antenna for different frequency bands often results in efficiency losses for transmission at least in one of the frequency bands.

### SUMMARY OF THE INVENTION

It is accordingly an object of the invention to provide a mobile electronic device, particularly a hearing aid, with a loop antenna, which overcomes the hereinafore-mentioned disadvantages of the heretofore-known devices of this general type and which is suitable for efficiently transmitting (sending/receiving) in different frequency bands.

With the foregoing and other objects in view there is provided, in accordance with the invention, a mobile electronic device, particularly a hearing aid, with a loop antenna having a conductor loop with a plurality of electric components, such as a plurality of capacitances formed by capacitors, and a plurality of inductances formed by coils. The loop antenna is configured as a multi-band antenna and has a first resonance frequency and a second resonance frequency greater than the first resonance frequency.

First, the conductor loop generally has a specified length in which the plurality of components are disposed so as to be distributed. Therefore, the conductor loop in its entirety is divided into a plurality of conductor portions interconnecting the individual components.

In the present configuration, the behavior of capacitors (capacitances) on the one hand and of inductances (coils) on the other hand is deliberately exploited. As such, on the one hand at low frequencies, particularly at the low first resonance frequency, only or at least mainly the capacitances are active and determine the behavior of the loop antenna. On the other hand, at the higher, second resonance frequency, only or at least mainly the inductances are active and determine the behavior of the loop antenna.

A respective pair formed of a capacitor and a coil electrically forms a series resonant circuit. Therefore, a plurality of series resonant circuits is disposed in the conductor loop, wherein an alternating sequence of the capacitors and the coils is not absolutely necessary.

In a preferred configuration, the conductor loop with the components disposed therein has an impedance which is capacitive at the first resonance frequency and is inductive at the second resonance frequency. Particularly, this means that the electric behavior of the conductor loop at the first resonance frequency is describable purely by loading with capacitances, and the electric behavior at the second resonance frequency is describable purely by loading with inductances. Loading herein refers to an arrangement of capacitances and/or inductances in the conductor loop.

A respective component pair (series resonant circuit) may be replaced with a (suitably adapted) capacitance at the first resonance frequency and with a (suitably adapted) inductance at the respective second resonance frequency.

Regarding each individual component pair, a respective pair in a preferred configuration has a capacitive impedance at the first resonance frequency and an inductive impedance at the second resonance frequency. Thus, if regarding an isolated individual component pair (without the other components of the conductor loop), a capacitive impedance would be measured at the first resonance frequency and an inductive impedance would be measured at the second resonance frequency.

It should be noted that a current distribution across the entire length of the conductor loop forms in both cases, i.e., at each of the two resonance frequencies. Therefore, in each case, the entire conductor loop is active across its entire length and determines the radiation behavior. Therefore, a current flow at the two frequencies is blocked by neither the inductances disposed in the conductor loop nor the capacitances disposed in the conductor loop.

In the concept described herein, different eigenmodes of the conductor loop are directly induced at the different resonance frequencies.

Preferably, the loop antenna is overall configured such that, during operation, a homogenous current distribution across the conductor loop occurs at the first resonance frequency and a wave-shaped current distribution across the conductor loop occurs at the second resonance frequency. Therefore, this corresponds to two different modes in which the loop antenna is operated at the two resonance frequencies. Therefore—as already mentioned above—a current distribution across the entire length of the conductor loop occurs in both cases.

The first mode with the homogenous current distribution forms a mode with a uniform current mode. Particularly, such a mode may be electrically formed/described by an exclusive loading of the loop with capacitances.

By contrast, the second mode with the wave-shaped current distribution preferably forms a full-wave loop antenna, in which a wave-shaped current distribution is formed according to a full wavelength (2 zero crossings, positive maximum, negative minimum). Particularly, such a mode may be electrically formed/described by an exclusive loading of the loop with inductances. Particularly, the two modes also differ in terms of their radiation characteristic.

As described above, the electric behavior at the first resonance frequency is determined by the capacitive loading and at the second resonance frequency by the inductive loading. This results in the electric length of the conductor loop being shorter relative to the physical (mechanical) length at the first resonance frequency. On the contrary, the electric length is preferably increased relative to the physical length at the second resonance frequency.

In general,—by suitably selecting the parameters such as length of the conductor loop, number of capacitors, selection of capacitance of the capacitors, number of coils, selection of inductances of the coils—using only one conductor loop, the same may be specifically tuned to the two different resonance frequencies. Therefore, the capacitors and coils, in conjunction with a specified length of the conductor loop, are specifically selected such that the two desired resonance frequencies and particularly the two different modes occur.

Resonance frequency is particularly understood herein as a frequency at which the so-called S1.1 parameter has a visible negative resonance peak. The S1.1 parameter generally indicates the reflecting behavior of an antenna as a function of the frequency of an electromagnetic wave. Therefore, a negative resonance peak of the S1.1 parameter means a correspondingly weak reflection and hence a good absorption of the antenna. The frequency position of a minimum of the resonance peak defines a resonance frequency.

In a preferred configuration, the two resonance frequencies are tuned to different Bluetooth frequency bands, i.e., different frequency bands according to the Bluetooth standard. Particularly, the first resonance frequency is at 2.44 GHz, and the second resonance frequency ranges from 5 GHz to 7 GHZ. Particularly, the second resonance frequency ranges from 5.1 to 6.5 GHZ.

If a resonance frequency band of a Bluetooth frequency band is mentioned herein, it particularly refers to the respective center frequency of a Bluetooth frequency band according to the Bluetooth standard, particularly according to the Bluetooth Low Energy (LE) standard. The conventional frequency band at 2.4 GHz extends between 2.40 and 2.48 GHZ, therefore having a bandwidth of about 80 MHz, and thus, the resonance frequency is at 2.44 GHZ.

There are other Bluetooth frequency bands specifically in the 5 GHZ range, for example the frequency band from 5.15-5.25 GHz with a bandwidth of 100 MHz, a frequency band from 5.725-5.850 GHz with a bandwidth of 125 MHz, a frequency band from 5.850-5.925 GHz with a bandwidth of 75 MHz, and a frequency band from 5.925-6.425 GHz with a bandwidth of 500 MHz. Particularly, the second resonance frequency is a center frequency of one of these frequency bands mentioned above.

In addition, further Bluetooth frequency bands are considered, with a center frequency ranging from about 6.4 GHz to about 7 GHZ.

Therefore, by tuning the loop antenna to two Bluetooth frequencies, communication is generally improved, since communication may be and preferably is performed via different frequency bands during operation.

Particularly, with hearing aids, Bluetooth communication is used for communicating with another device, such as for example a hand-held device such as a smartphone, wherein the hearing aid may preferably be controlled and/or set via this hand-held device, and/or music/speech may be streamed to the hearing aid.

If hearing aid is mentioned herein, it generally refers to a device wearable in or at the ear, via which hearing signals and particularly acoustic receiver signals are transmitted to the user. Specifically for this purpose, the hearing aid generally also has a loudspeaker labeled as receiver, via which acoustic output signals may be delivered to the user's ear canal. In general, the hearing aid may be conventional headphones.

Preferably, however, the hearing aid is a hearing assistive device in which a signal is processed to compensate at least partially for a user-specific hearing impairment. For this purpose, digital signal processing is periodically implemented in the hearing aid, through the use of which an (electric) input signal is typically decomposed into a plurality of frequency bands. The input signal decomposed into frequency bands, where applicable, is subjected to signal processing according to the user-specific hearing impairment prior to an electric output signal being delivered (where the frequency bands have been recombined). In order to generate the electric input signal, at least one acoustic-electric input transducer (microphone) is typically integrated in the hearing aid, which converts an acoustic input signal to the electric input signal. Similarly, an electro-acoustic output transducer (loudspeaker, receiver) is typically implemented in the hearing aid, which converts the electric output signal to an acoustic output signal which is then specifically delivered to the user's ear canal. Alternatively, instead of an acoustic output signal, a non-acoustic output signal, e.g. in a bone conduction hearing aid—may be output via a suitable transducer.

Particularly, the hearing aid is an in-the-ear (ITE), receiver-in-channel (RIC) or behind-the-ear (BTE) hearing aid, the general configurations of which are widely known.

However, the invention described herein relating to the specific configuration of the loop antenna is not limited to a hearing aid, but may also be generally employed in mobile devices. Mobile devices generally refer herein to wearable devices, such as for example tablets, laptops, smartphones, etc., which may be operated in a mobile, i.e. location-independent, manner.

Regarding the integration of coils and capacitors in the conductor loop, preferably a plurality of component groups are formed, each of which have one, and particularly exactly one, capacitor and particularly exactly one coil. Specifically, each component group is formed by exactly one capacitor and exactly one coil. Therefore, a respective assembly forms a series resonant circuit. A plurality of such component groups are installed in the conductor loop, as already explained above. The various component groups are each interconnected via conductor portions of the conductor loop. In other words, each conductor loop is divided by such a component group, i.e. a series resonant circuit, into the different conductor portions.

Preferably, at least three component groups and preferably 5-10 component groups are installed in the conductor loop. For example, particularly, seven component groups are installed in the conductor loop. This number allows for a favorable distribution of the individual component groups and a suitable sizing, such that an efficient multi-band antenna is achieved overall.

In an appropriate configuration, the individual components—and in the case of the component groups described above—the component groups, are disposed in a distributed manner across the entire length of the conductor loop, particularly in an evenly distributed manner. Evenly distributed refers to an equal distance being set between every two adjacent components or two adjacent component groups, such that each conductor portion between two adjacent components or adjacent component groups has the same length. Only in the region of the feeding point, the two components/component groups disposed on both sides thereof may have a different distance to one another.

In case of the component groups, in which a respective capacitor and coil together form a component group, they are only interconnected via a connecting conductor piece not being considered herein as a conductor portion. In general, such a connecting conductor piece is also significantly shorter (by a factor of at least five or a factor of at least ten) than a conductor portion between two adjacent component groups.

By integrating the components, specifically the capacitors, the particular advantage is achieved that the conductor loop has a physical length smaller than the wavelength (in vacuum) of an electromagnetic wave at the first resonance frequency. Overall, a compact configuration of the loop antenna is achieved. For example, the wavelength at a first resonance frequency of 2.44 GHz is about 12.3 cm. If a frequency for the second resonance frequency is selected to be 5.2 GHz, for example, then the associated electromagnetic wave has a wavelength of about 5.8 cm.

Physical length of the conductor loop refers to the actual (mechanical) length of the conductor loop, i.e., the sum of all the loop portions plus the longitudinal portions occupied by the components/component groups.

In a preferred configuration, the conductor loop has a physical length corresponding to the length (circumference) of a circle with a circle radius ranging from 5 mm to 15 mm or from 5 mm to not higher than 10 mm. Specifically, the physical length is below half, and preferably less than 40%, of the wavelength of an electromagnetic wave at the first resonance frequency, such that a particularly compact configuration is achieved. As such, for example, the physical length is at a length corresponding to a circle with a radius of 0.7 cm, resulting in a physical length of about 4.4 cm.

Preferably, the physical length is sized such that it is smaller than the wavelength of an electromagnetic wave (vacuum wavelength) with the second resonance frequency. Particularly, the maximum physical length is smaller than the wavelength of a wave with the lowest frequency of the Bluetooth frequency band in which the second resonance frequency is located.

In a preferred configuration, the employed capacitors each have a capacitance ranging from 0.3 pF to 10 pF, and particularly from 0.5 pF to 3 pF. In general, the capacitance is selected to be as small as possible, but significantly greater (greater by a factor of at least 5 or a factor of at least 10), preferably by a factor of not higher than 10 or a factor of not higher than 15) than a tolerance of the capacitor component. The capacitance of a respective capacitor is—with a given loop length—greater, the more capacitors are installed. The specified values apply particularly in combination with the preferred number of capacitors of at least three and preferably of 5-10. This allows for the desired first resonance frequency to be set. Particularly, the number of capacitors also depends on the length of the conductor loop. The longer the conductor loop, the more components are provided. For example, while in a loop length corresponding to a radius of 5 mm, 4 to 5 capacitors are installed, twice as many capacitors (8 to 10) are installed in a loop length corresponding to a radius of 10 mm, for example.

Preferably, the (physical) length of a conductor portion, i.e, particularly between two series resonant circuits, is generally less than or equal to a fifth or less than or equal to a tenth of the wavelength (vacuum wavelength) at the first resonance frequency.

In a preferred configuration, the employed coils each have an inductance ranging from 1 nH to 20 nH and particularly ranging from 1 nH to 10 nH. This particularly applies in combination with the preferred number of coils of at least three and preferably of 5-10. This allows for the desired second resonance frequency to be set. The inductance of a respective coil is—with a given loop length—smaller, the more coils are installed.

In a preferred configuration, all the coils and/or capacitors are configured identically. Therefore, they each have the same capacitance and inductance, respectively. Specifically, they are configured as carry-over parts.

Preferably, a loop antenna generally refers to an antenna in which an electric conductor, starting from a feeding point, has a loop-shaped course and is routed back to the feeding point. For example, the loop antenna, and thus the conductor loop, has a circular course, but alternatively, also other loop-shaped courses are generally possible depending on the respective application. The (physical) length of the conductor loop is defined by the length starting from the feeding point and back to the feeding point.

As is common practice, a so-called feed line is connected at the feeding point, which is connected to suitable electronics. Therefore, the loop antenna is a so-called loaded loop antenna. In sending, a suitable antenna signal is delivered via these electronics and is fed into the conductor loop via the feed line.

On the contrary, in the receiving mode, an electromagnetic wave received from the conductor loop is decoupled at the feeding point into the feed line and is transmitted to the electronics, through the use of which the received antenna signal is then evaluated and further processed.

At the feeding point, in a known manner, preferably inductively coupling/decoupling is performed by a feeding coil, or alternatively also capacitively coupling/decoupling is performed. Inductively coupling compensates for a capacitive input impedance of a short electric antenna, for example. Capacitively coupling compensates for an inductive input impedance of a small magnetic antenna, for example.

Other features which are considered as characteristic for the invention are set forth in the appended claims.

Although the invention is illustrated and described herein as embodied in a mobile electronic device, particularly a hearing aid, with a loop antenna, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic plan view of a loop antenna with a conductor loop having a plurality of component groups formed by LC parts with associated electronics;

FIG. 2 is a diagram showing a signal course of the S1.1 parameter for a loop antenna illustrated in FIG. 1;

FIG. 3 is a diagrammatic plan view of the current distribution in the conductor loop with a homogenous current distribution in a uniform current mode;

FIG. 4 is a diagrammatic plan view of the current distribution in the conductor loop with a wave-shaped current distribution in a full wave current mode; and

FIG. 5 is a cross-sectional view of a hearing aid.

### DETAILED DESCRIPTION OF THE INVENTION

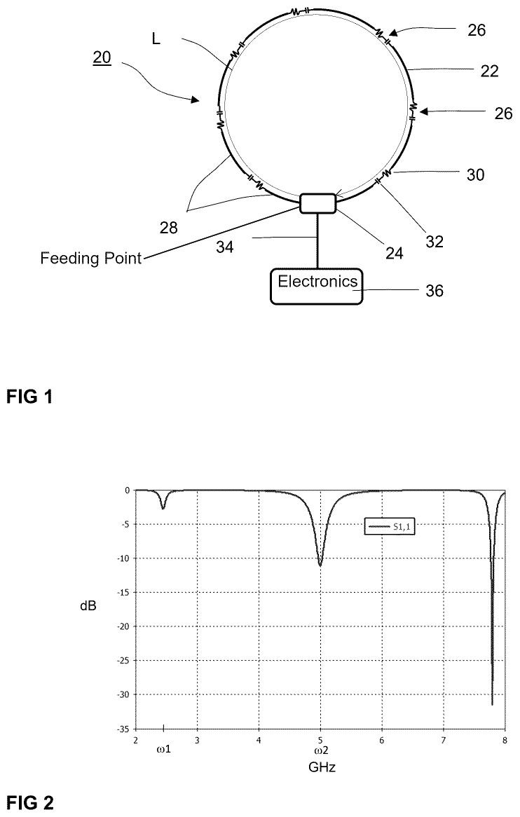

Referring now to the figures of the drawings in detail and first, particularly, to FIG. 1 thereof, there is seen a loop antenna 20 which has a conductor loop 22, the two ends of which are connected to a feeding point 24. The loop antenna 20 has a plurality of component groups 26 configured as LC parts, which are preferably disposed in an evenly distributed manner around the periphery of the conductor loop 22 in the embodiment. Alternatively, these may also be disposed in a non-evenly distributed manner. A conductor portion 28 of the conductor loop 22 is formed between every two adjacent component groups 26. Due to the even distribution, the conductor portions 28 have identical lengths. Only the conductor portions 28 between the first or last component groups and the feeding point 24 have a different length, for example, or have the same length as the other conductor portions 28. The individual conductor portions 28 are typically formed by a conductor strand, such as for example a bare or also insulated conductor wire or conductor track, wherein the latter is formed on a printed circuit board, for example.

The conductor loop 22 has a physical length L determined by the length starting from the feeding point 24 and going back to the feeding point 24 (starting from the feeding point, then the conductor loop 22 in one direction, e.g., following clockwise, until the feeding point is reached again).

Each respective assembly 26 is formed of a coil 30 with a specified inductance and a capacitor 32 disposed in series therewith with a specified capacitance. The individual assemblies 26 are also disposed in series one after the other within the conductor loop 22. Overall, the component groups 26 form a series resonant circuit. In the embodiment, there are seven component groups 26 in total and they are preferably disposed in an evenly distributed manner.

In the embodiment illustrated, the capacitors 32 and the coils 30 are each disposed in an alternating manner to one another.

A feed line 34, which is installed at the feeding point 24, is connected to electronics 36. As is known in the art, an antenna signal generated by the electronics 36 is coupled to the conductor loop 22 via the feeding point 24 for sending. Similarly, upon receiving, a corresponding receiving signal received from the conductor loop 22 is decoupled into the feed line 34 and forwarded to the electronics 36 via the same.

Overall, the conductor loop 22 has a physical length corresponding to a circumference of a circle with a radius of 0.5 cm to 1.5 cm, for example, and particularly 0.5 cm-1 cm, for example.

Preferably, a respective capacitor 32 has a capacitance C_{S}, and a respective coil 30 has an inductance L_{S}.

In order to determine the values for the capacitance C_{S} and inductance L_{S}, the following auxiliary model may be used as a basis, for example:

Based on a conductor loop 22 with a specified length (and therefore also a given loop inductance), and a specified number of capacitors 32 (without coils 30 and without other components), the capacitance thereof is selected/set such that a desired first resonance frequency ω1 of 2.44 GHZ, for example, is obtained. The capacitance determined by this forms an auxiliary capacitance C1. For example, the number of capacitors 32 is between five and ten, which has proved to be a good compromise regarding high efficiency and low noise.

In such a (hypothetical) conductor loop 22 with capacitors 32 disposed therein exclusively in a distributed manner, a uniform current distribution across the periphery of the conductor loop 22 would form, which corresponds to a uniform current mode and thus to a magnetic loop antenna.

In the case of tuning to 2.44 GHz as a first resonance frequency ω1, the S1.1 parameter correspondingly shows a significant drop at the first resonance frequency ω1. Furthermore, there is another decreasing reflection intensity at higher frequencies above 6 GHZ, and particularly, another resonance peak is visible in the range of about 8 GHZ, for example. In this case, the wavelength of the other resonance peak corresponds at least largely to the physical length of the conductor loop 22.

Similarly to determining the auxiliary capacitance C1, based on the conductor loop 22 (same physical length as above) with a number of coils 30 equal to the number of capacitors (without capacitors 32 and without any other components), their respective inductance is selected/set such that a desired second resonance frequency ω2 of 5 GHZ, for example, is obtained. The inductance determined by this forms an auxiliary inductance L1.

In such a (hypothetical) conductor loop 22 with coils 30 disposed therein exclusively in a distributed manner, a wave-shaped current distribution around the conductor loop 22 would form according to a full wavelength (2 zero crossings, positive maximum, negative minimum), and therefore a full-wavelength mode of a full wave loop antenna would result.

For example, in the case of tuning to 5 GHz as a second resonance frequency ω2, the S1.1 parameter correspondingly shows a significant drop at the second resonance frequency ω2.

For the loop antenna 20 according to FIG. 1 with the plurality of component groups 26, the capacitances C_{S} and the inductances L_{S} may be determined according to the following formulas, for example, wherein C1 is the auxiliary capacitance, L1 is the auxiliary inductance, ω1 is the first resonance frequency, and ω2 is the second resonance frequency:

$${C}_{s} = {C}_{1} \frac{{ω}_{2}^{2} - {ω}_{1}^{2}}{{ω}_{1}^{2} {ω}_{2}^{2} {L}_{1} {C}_{1} + {ω}_{2}^{2}}$$

$${L}_{s} = \frac{{ω}_{2}^{2} {L}_{1} {C}_{1} + 1}{{C}_{1} ( {ω}_{2}^{2} - {ω}_{1}^{2} )}$$

Due to the fact that basically only the capacitors 32 determine the transmission behavior at the low, first resonance frequency, the uniform current distribution according to the uniform current mode forms at the first resonance frequency ω1.

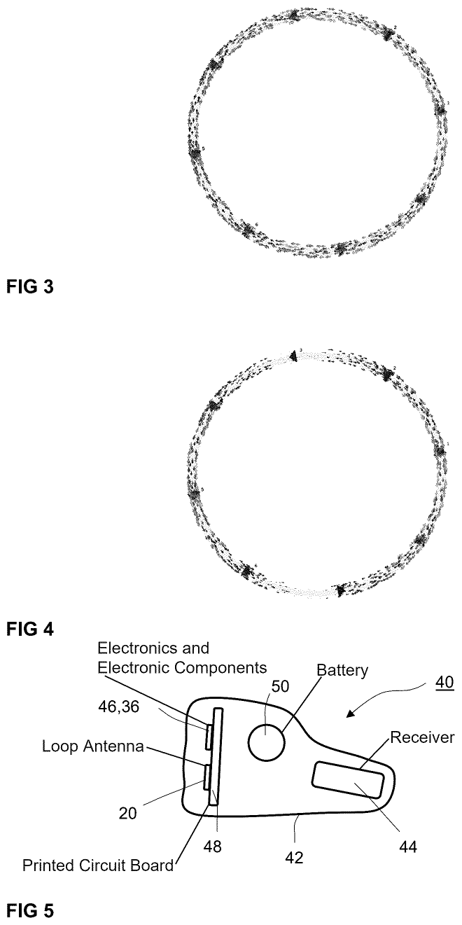

The current distribution in this uniform current mode is diagrammatically illustrated in FIG. 3. It is visible that a homogenous current distribution occurs across the entire length of the conductor loop. Therefore, an even current density/current flow occurs at each point of the conductor loop.

On the contrary, the wave-shaped current distribution with a varying current density according to the full wavelength mode forms at the higher second resonance frequency ω2, since in this case, the transmission behavior is determined by the coils 30.

The current distribution in this full wavelength mode is diagrammatically illustrated in FIG. 4. It is visible that a wave-shaped current distribution according to a full wave forms across the entire length of the conductor loop. Therefore, the wavelength of this current distribution particularly corresponds to the length of the conductor loop. Particularly, there are exactly two maxima (a positive and a negative maximum) forming, each with a zero crossing therebetween. In FIG. 4, the zero crossings are illustrated at about the 12 o'clock position and 6 o'clock position, and the two maxima are illustrated at the 3 o'clock position and 9 o'clock position.

In FIG. 3 and FIG. 4, the current density/current flow in a respective portion of the conductor loop 22 is illustrated by points/small arrows. A high density of points corresponds to a high current density, and a low density of points corresponds to a low current density. In FIG. 4, it is well visible that there are no points/current density in the region of the 12 o'clock position and 6 o'clock position, i.e., in the region of the zero crossings. Contrary to that, in FIG. 3, the density of the points and thus the current density is constant across the entire circumference.

The courses of the S1.1 parameters described above overlap one another and thereby form a common course, as illustrated by way of example in FIG. 2. The attenuation of the S1.1 parameter (in dB) relative to the frequency (in GHz) is indicated. The first (negative) resonance peak is well visible at the first resonance frequency ω1 of 2.44 GHz in the embodiment, and additionally, the second (negative) resonance peak is well visible at the second resonance frequency ω2 of 5 GHz in the embodiment.

Additionally, in the embodiment, another resonance peak is visible at slightly below 8 GHZ, which corresponds to another resonance peak, as explained above with respect to determining the auxiliary capacitance C1.

Therefore, using the measures described herein, two resonance frequencies are set in a common loop antenna 20 in a particularly simple and efficient manner.

The main radiation characteristics of the loop antenna 20 at the two resonance frequencies ω1, ω2, i.e., the spatial directions in which the main intensity of the antenna radiation is delivered (in the case of sending or the receiving sensibility upon receiving), differ from one another, they may be orthogonal to one another in the pure loop antenna 20, for example. However, the radiation characteristic is affected by various other influencing factors, such as for example the other electric components within a hearing aid 40, but also due to placement at or in the ear. Overall, using only one compactly configured loop antenna 20, a plurality of transmission frequencies may be utilized for communicating with other devices, with good efficiency for both resonance frequencies.

In FIG. 3, the hearing aid 40 mentioned above is illustrated by way of example and greatly simplified. The hearing aid 40 is, for example, configured as an in-the-ear (ITE) hearing aid, is inserted into the ear and the front section thereof is inserted into a user's ear canal. Such a hearing aid 40 generally has a housing 42, within which the required hearing aid components are installed. Particularly, in the case of an ITE hearing aid 40, these are a receiver 44, various electronic components 46 all installed on a printed circuit board 48, for example, and forming a so-called faceplate with the same, for example, which is typically installed at the rear end of the housing 42 opposite the receiver 42 and particularly sealing an interior of the housing 42. Furthermore, typically at least one and preferably a plurality of microphones (not illustrated herein) are installed as acoustic-electric sound transducers in the hearing aid 40. Furthermore, a battery 50 is installed in the housing 42. An acoustic input signal, which is converted to an electric input signal via the at least one microphone, is processed by digital signal processing depending on the user-specific hearing impairment, and subsequently an electric output signal is output, which is converted to an acoustic output signal in the receiver 44 and delivered to the user's ear canal via a sound channel.

For example, the loop antenna 20 described herein is installed on the printed circuit board 48, and preferably at least the electronics 36 described above are formed on the printed circuit board 48. For example, the conductor loop 22 is configured as a conductor track on this printed circuit board 48, wherein the individual conductor portions 28 are formed by various portions of conductor tracks, and respective component groups 26 are formed between these conductor portions 28, for example also as conductor track regions being suitably configured. Particularly for the component groups 26, specifically components configured as a coil 30 and capacitor 32 are formed as pre-manufactured components with the printed circuit board 48 electrically contacted, particularly soldered, at defined contact locations, for example. Alternatively to integrating the conductor loop 22 on the printed circuit board 48, the conductor loop 22 may also be routed within the housing 42 or along a housing wall.

The following is a summary list of reference numerals and the corresponding structure used in the above description of the invention:
20 Loop antenna
22 Conductor loop
24 Feeding point
26 Component group
28 Conductor portion
30 Coil
32 Capacitor
34 Feed line
36 Electronics
40 Hearing aid
42 Housing
44 Receiver
46 Electronic components
48 Printed circuit board
50 Battery
L_{S} Inductance
C_{S} Capacitance
ω1 First resonance frequency
ω2 Second resonance frequency
L Physical length of the conductor loop

1. A mobile electronic device or hearing aid, comprising:
a loop antenna having a conductor loop with a plurality of electric components (32, 30);
said loop antenna being configured as a multi-band antenna having a first resonance frequency and a second resonance frequency being greater than said first resonance frequency.

2. The mobile electronic device according to claim 1, wherein said plurality of electric components are a plurality of capacitors and a plurality of coils.

3. The mobile electronic device according to claim 1, wherein said conductor loop with said plurality of electric components disposed therein has an impedance being capacitive at said first resonance frequency and inductive at said second resonance frequency.

4. The mobile electronic device according to claim 3, wherein said conductor loop has an electric behavior at said first resonance frequency describable purely by loading with capacitances, and said conductor loop has an electric behavior at said second resonance frequency describable purely by loading with inductances.

5. The mobile electronic device according to claim 1, wherein said loop antenna is configured to cause, during operation, a homogenous current distribution across said conductor loop to occur at said first resonance frequency and a wave-shaped current distribution across said conductor loop to occur at said second resonance frequency.

6. The mobile electronic device according to claim 5, wherein said loop antenna is configured to cause, during operation, a wave-shaped current distribution of an entire wavelength across said conductor loop to occur at said second resonance frequency.

7. The mobile electronic device according to claim 1, wherein said first resonance frequency is at 2.44 GHZ, and said second resonance frequency ranges from 5 GHz to 7 GHz.

8. The mobile electronic device according to claim 1, which further comprises:
a plurality of component groups installed in said conductor loop;
a respective one of said component groups being formed by a capacitor and a coil; and
said respective one of said component groups being installed between two adjacent conductor portions of said conductor loop.

9. The mobile electronic device according to claim 8, wherein at least three of said component groups are installed in said conductor loop.

10. The mobile electronic device according to claim 8, wherein five to ten of said component groups are installed in said conductor loop.

11. The mobile electronic device according to claim 1, wherein said electric components are evenly distributed across said conductor loop.

12. The mobile electronic device according to claim 8, wherein said plurality of components groups are evenly distributed across said conductor loop.

13. The mobile electronic device according to claim 1, wherein said conductor loop has a physical length being smaller than a wavelength of a wave at said first resonance frequency.

14. The mobile electronic device according to claim 1, wherein said conductor loop has a physical length corresponding to a length of a circle with a circle radius ranging from 5 mm to 15 mm.

15. The mobile electronic device according to claim 1, wherein said conductor loop has a physical length corresponding to a length of a circle with a circle radius not greater than 10 mm.

16. The mobile electronic device according to claim 2, wherein said capacitors have a capacitance ranging from 0.3 to 10 pF.

17. The mobile electronic device according to claim 2, wherein said capacitors have a capacitance ranging from 0.5 pF to 3 pF.

18. The mobile electronic device according to claim 2, wherein said coils have an inductance ranging from 1 nH to 20 nH.

19. The mobile electronic device according to claim 2, wherein said coils have an inductance ranging from 1 nH to 10 nH.

20. The mobile electronic device according to claim 2, wherein at least one of:
all of said coils are configured identically, or
all said capacitors are configured identically.

21. The mobile electronic device according to claim 1, wherein said loop antenna has a feeding point, and a feed line is connected to said feeding point.
